(19) United States
(12) Patent Application Publication
(10) Pub. No.: US 2014/0158478 A1
(43) Pub. Date: Jun. 12, 2014

(54) SEPARATOR PLATE

(71) Applicant: CATERPILLAR INC., Peoria, IL (US)

(72) Inventor: Ian Leonard Macdonald, Hoffman Estates, IL (US)

(73) Assignee: Caterpillar Inc., Peoria, IL (US)

(21) Appl. No.: 13/712,507

(22) Filed: Dec. 12, 2012

(51) Int. Cl. F16D 65/853; F16D 65/092

(52) U.S. Cl. CPC F16D 65/853; F16D 65/092
USPC 188/71.5; 188/250 B

(57) ABSTRACT

A separator plate is disclosed. The separator plate may include a plate-like ring including an inner diameter, an outer diameter, and a thickness. The separator plate further includes a generally smooth surface disposed on opposing sides of the plate-like ring spaced apart by the thickness and a plurality of apertures extending from the inner diameter to the outer diameter within the thickness of the ring. The cross-section of each of the plurality of apertures remains generally consistent in cross-sectional are along the extent from the inner diameter to the outer diameter.

### TECHNICAL FIELD

The present disclosure is directed to a separator plate and, more particularly, to a separator plate having apertures.

### BACKGROUND

Machines, including on and off-highway haul and vocational trucks, wheel loaders, motor graders, and other types of heavy equipment generally include an oil-cooled hydraulic braking system. In an oil-cooled hydraulic braking system, multiple brake disks are placed over a brake hub and wheel axle, and separator plates are placed between each brake disk. Hydraulic oil runs through the brake system and in between the alternating brake disks and separator plates. The oil creates a film on the brake disks and separator plates, helping to prevent direct contact between the compressed rotating surfaces and extend brake life. The hydraulic oil also serves to cool the braking system. Standard brake hubs may trap oil and heat, preventing adequate cooling of their associated components. Also, standard separator plates do not allow the oil to pass through while the brake is engaged.

An exemplary separator plate is described in U.S. Pat. No. 6,585,095 (“the '095 patent”) of Savoyard et al. that issued on Jul. 1, 2003. The '095 patent describes a separator plate for use in a rotating clutch package having oil for lubricating and cooling. The '095 patent separator plate has lubricating passages through the body of the plate that allow oil to pass through as the separator plates spin with the clutch assembly when the clutch is engaged. The passages of the '095 patent push oil radially outward by centrifugal force, thereby improving oil circulation and cooling.

Although the separator plates of the '095 patent may be capable of improving cooling in a clutch assembly, it may be suboptimal in a brake package. First, because the separators plates in a brake package do not rotate, the passages proposed in the '095 patent may not effectively transmit cooling oil through the separator plate when used in a brake system rather than a clutch system. Second, oil weight and temperatures in a brake system may be different than those in a clutch system and the passages of the '095 patent may not adequately allow for cooling in a brake environment.

The separator plate of the present disclosure solves one or more of the problems set forth above and/or other problems of the prior art.

### SUMMARY

One aspect of the present disclosure is directed to a separator plate for a brake assembly. The separator plate may include a plate-like ring having an inner diameter, an outer diameter, and a thickness. A generally smooth surface is disposed on each side of the plate-like ring spaced apart by the thickness. A plurality of apertures extends from the inner diameter to the outer diameter within the thickness of the ring. A cross-section of each of the plurality of apertures remains generally consistent in cross-sectional area along the extent from the inner diameter to the outer diameter

Another aspect of the present disclosure is directed to a leg housing. The leg housing may include a body portion having a first end and a second end, and a flange disposed at the first end. The flange may include a first conduit extending from an outer surface of the flange toward an interior volume of the body portion. The first conduit may be disposed approximately at an assembled two o'clock position of the flange. The flange may also include a second conduit extending from the outer surface of the flange toward the interior volume of the body portion. The second conduit may be disposed approximately at an assembled ten o'clock position of the flange. The flange may also include a third conduit formed in an assembled gravitational lower half of the flange.

### BRIEF DESCRIPTION OF THE DRAWINGS

FIG. 1 is a pictorial illustration of an exemplary disclosed drive assembly;

FIG. 2 is a cross-sectional illustration of the drive assembly of FIG. 1;

FIG. 3 is an enlarged cross-sectional illustration of a portion of the drive assembly of FIG. 2;

FIG. 4 is a pictorial illustration of an exemplary disclosed brake hub of FIG. 4;

FIG. 5 is a pictorial illustration of the exemplary disclosed separator plate that may be used with the drive assembly of FIG. 2;

FIG. 6 is a pictorial front view illustration of the exemplary sub-plate for forming the separator plate of FIG. 5; and

FIG. 7 is a pictorial rear view illustration of the exemplary sub-plate for forming the separator plate of FIG. 5.

### DETAILED DESCRIPTION

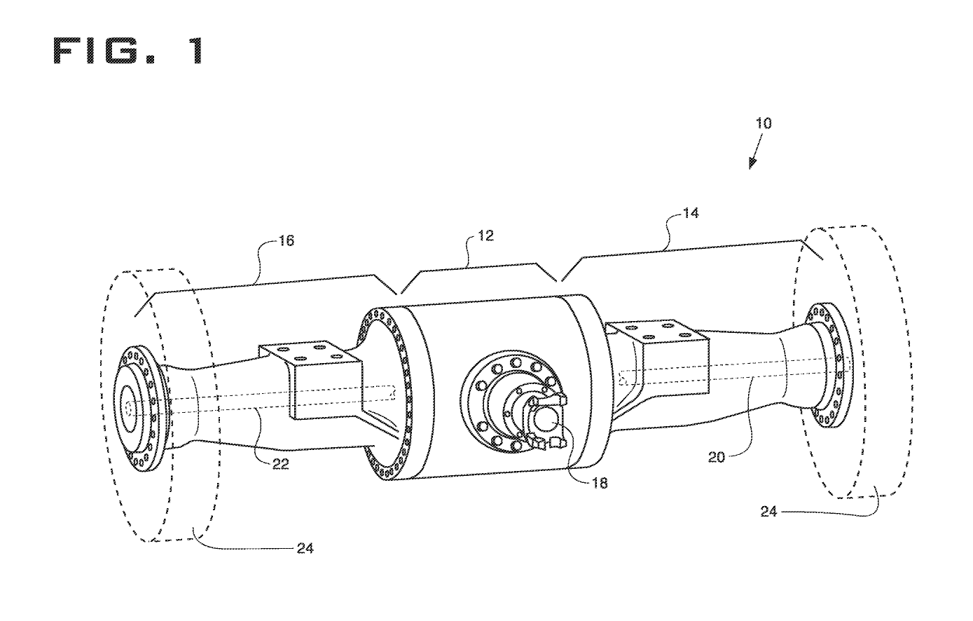

FIG. 1 illustrates an exemplary disclosed drive assembly 10. Drive assembly 10 may be associated with a mobile vehicle (not shown) so as to propel the vehicle. As such, drive assembly 10 may include a differential assembly 12 and first and second final drive assemblies 14, 16. An input member such as a driveshaft 18 may drivingly connect a power source (e.g., an engine and transmission, both of which are not shown) of the vehicle to differential assembly 12. Two output members such as a first output shaft 20 and a second output shaft 22 may drivingly connect final drive assemblies 14, 16 to traction devices 24 located on opposing sides of the vehicle. In one embodiment, traction devices 24 may embody wheels. Final drive assemblies 14, 16, may be drivingly coupled to differential assembly 12 such that a rotation of driveshaft 18 results in a corresponding rotation of output shafts 20, 22 and traction devices 24.

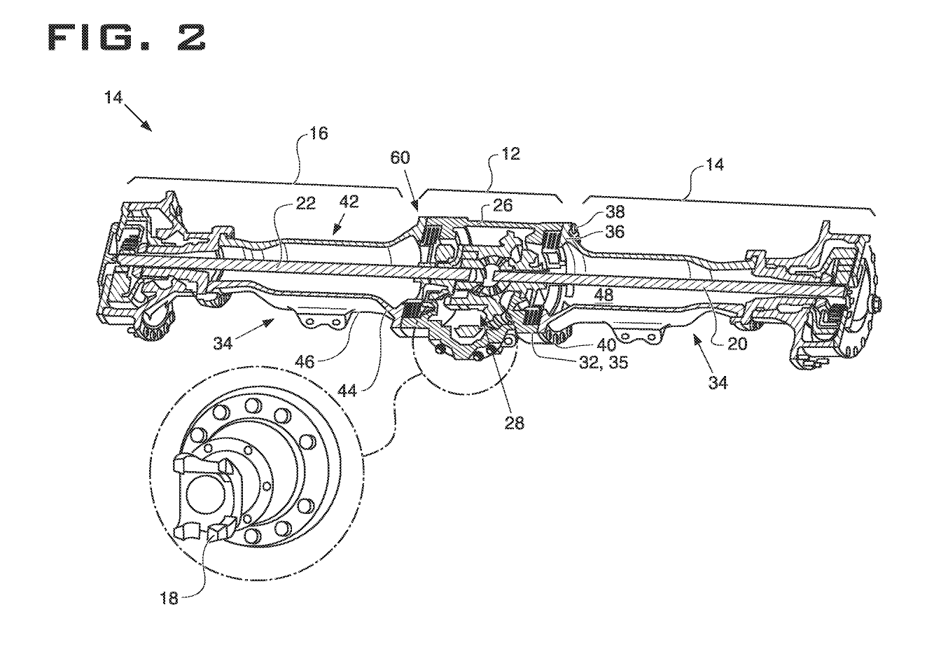

As illustrated in FIG. 2, differential assembly 12 may include a center housing 26 and a differential gear arrangement 28 supported within center housing 26. Center housing 26 may be a generally cylindrical housing having an axial direction substantially aligned with output shafts 20, 22. One or more bearings may be located within center housing 26 to support the rotation of output shafts 20, 22. Driveshaft 18 may extend through a side of center housing 26 to engage and rotationally drive differential gear arrangement 28. In turn, differential gear arrangement 28 may operatively engage and transfer the input rotation of driveshaft 18 to output shafts 20, 22. At each opposing end of center housing 26, an end face 32 may be located to engage and seal against a leg housing 34 of final drive assemblies 14, 16 (i.e., final drive assemblies 14 and 16 may have associated leg housings 34 that are substantially identical to each other). Specifically, end face 32 of center housing 26 may abut an end face 35 of each leg housing 34. A sealing element such as, for example, a gasket (not shown) may be inserted between end faces 32 and 35 of center and leg housings 26, 34, if desired, to improve fluid sealing at that interface. End face 35 may be part of a mounting flange 36.

Leg housing 34 of each final drive assembly 14, 16 may enclose and support a planetary gear arrangement and an associated one of output shafts 20, 22. Leg housing 34 may be connected to center housing 26 by way of, for example, threaded fasteners 38 located around an outer rim 40 of mounting flange 36. Leg housing 34 may include a body portion 42 that is integral with mounting flange 36. Body portion 42 may include a conical portion 44 and a cylindrical portion 46. Conical portion 44 and cylindrical portion 46 may define an interior volume 48 of leg housing 34.

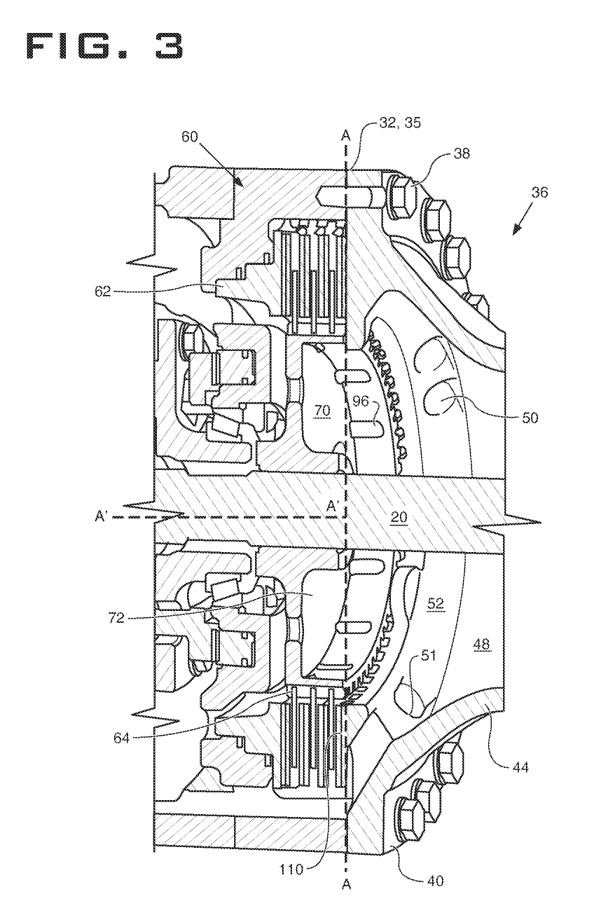

Referring to FIG. 3, mounting flange 36 may include a plurality of conduits 50 that extend from end face 35 toward interior volume 48 of leg housing 34. Conduits 50 may terminate at a beveled annular surface 52 within interior volume 48. In one exemplary embodiment, a pair of conduits 50 are disposed at an assembled two o'clock position of mounting flange 36 (as viewed from an axial end of leg housing 34). In another exemplary embodiment, a pair of conduits 50 may be disposed at an assembled ten o'clock position on mounting flange 36. That is, two pairs of conduits 50 may be symmetrically arranged with respect to reference axis A-A, with one pair of conduits 50 being disposed approximately at the assembled two o'clock position and the remaining pair of conduits 50 approximately disposed at the assembled ten o'clock position. An additional conduit 51 may be disposed at an assembled gravitational lower half of mounting flange 36. It is further contemplated that another suitable number of conduits 51 may be disposed at an assembled lower half of mounting flange 36. In one exemplary arrangement, two conduits 51 are included and are symmetrically arranged with respect to reference axis A-A, although another suitable arrangement may alternatively be utilized.

Referring to both FIGS. 2 and 3, drive assembly 10 may be equipped with an internal braking system 60 (i.e., braking system 60 may be at least partially enclosed by center housing 26 and leg housing 34) configured to resist the rotation of output shafts 20, 22. Braking system 60 may include a selectively movable actuator 62, one or more brake disks 64, and one or more separator plates 110. Brake disks 64 may be splined on to a brake hub 70, and separator plates 110 may be splined or otherwise fixed on to leg housing 34. That is, brake disks 64 may be connected to rotate with output shafts 20, 22 via brake hub 70 that is splined on to output shafts 20, 22 such that, when actuator 62 is acted on by pressurized fluid, brake disks 64 may be sandwiched or compressed between alternating separator plates 110, creating friction that resists the rotation of output shafts 20, 22.

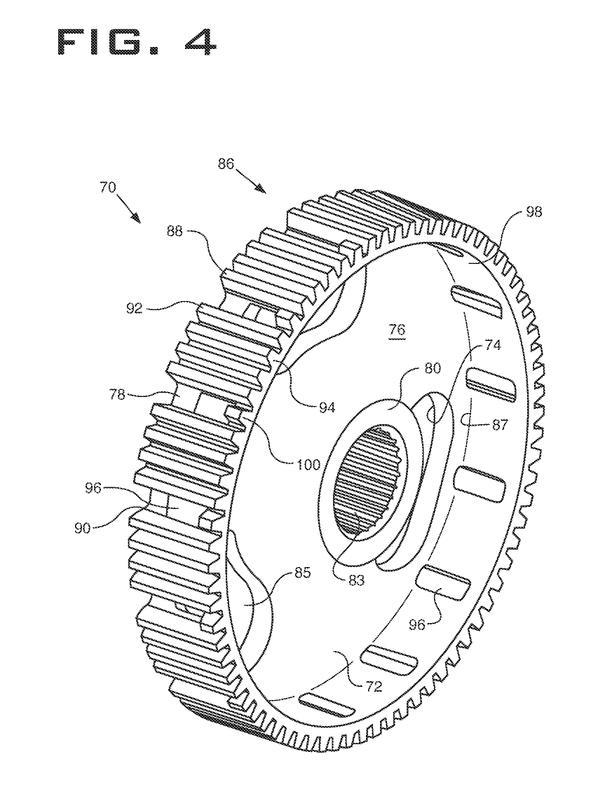

Referring to FIG. 4, brake hub 70 may have a cylindrical body portion 72 with a first end 74, a second end 76, and an outer edge 78. A flange 80 may be disposed at a geometric center of cylindrical body portion 72, and extend outward from first end 74 of cylindrical body portion 72. Flange 80 may enclose a center aperture 83 that extends from first end 74 to second end 76. Brake hub 70 may also include axial apertures 85 formed in cylindrical body portion 72. Apertures 85 may be kidney-shaped and evenly spaced, although other suitable shapes and spacing may alternatively be utilized. In one exemplary embodiment, brake hub 70 includes three kidney-shaped apertures 85 spaced about 120° from each other to ensure balanced rotation of brake hub 70.

Brake hub 70 may also include an outer rim 86 that extends from outer edge 78 in a second direction. Cylindrical body portion 72 and outer rim 86 may be generally perpendicular surfaces that meet at a junction 87. A plurality of splines 88 may be disposed on an outer annular surface 90 of outer rim 86 and extend in the second direction from a first end 92 to a second end 94 of outer rim 86. Outer rim 86 may include a plurality of radial apertures 96 that extend from an inner annular surface 98 through outer annular surface 90. An equal number of splines 88 may be disposed between each aperture 96. Apertures 96 may also extend in the second direction, from junction 87 toward second end 94 of outer rim 86. Apertures 96 may extend only partially along outer rim 86, terminating at partial splines 100. Splines 100 may be disposed along outer rim 86, extending from an end of an aperture 96 toward second end 94 of outer rim 86.

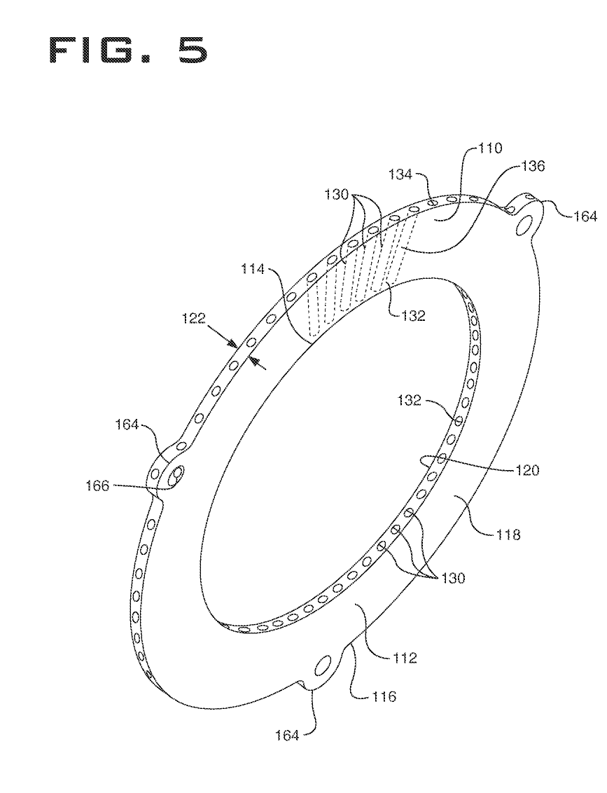

Referring to FIG. 5, separator plate 110 may be in the form of a plate-like ring 112. The separator plate 110 has an inner diameter 114 and an outer diameter 116 spaced apart by generally smooth surfaces disposed on opposing sides 118, 120 of the separator plate 110. The opposing sides 118, 120 are separated from each other by the thickness 122 of the plate.

A plurality of apertures 130 is provided in the separator plate 110. The apertures 130 fluidly extend from the inner diameter 114 to the outer diameter 116 and are contained within the thickness 122 of the separator plate 110. In an exemplary embodiment, the apertures 130 extend radially between the inner diameter 114 and the outer diameter 116. Each aperture 130 has a cross-section 132 that remains generally consistent in cross-sectional area between an opening 132 at the in the inner diameter 114 and an opening 134 at the outer diameter 116. The apertures 130 are generally circular in cross-section. The cross-sectional area of each aperture 130 is in the range of about 15 mm² to about 30 mm². In an alternative embodiment, the aperture may have a square or rectangular cross-section.

In order to ensure flow of cooling oil through the apertures 130 and for it to effectively cool the separator plate 110, it is necessary for there to be an adequate number of apertures in view of the cross-sectional area of the apertures 130, the inner diameter 114 and the outer diameter 116. The following equation may be used to determine the number of apertures 130 required for the separator plate:

$$π ( {OD}^{2} - {ID}^{2} ) = 4 A ( \frac{OD - ID}{2} ) η$$

where;

OD=outer diameter 116;

ID=inner diameter 114;

A=aperture cross-sectional area; and

η=number of apertures 130.

In an exemplary embodiment, the number of apertures 130 may be about 40 to about 80, preferably about 50 to about 70, and more preferably 60. The apertures 130 are generally arranged such that they extend in a radial direction from the inner diameter 114 to the outer diameter 116.

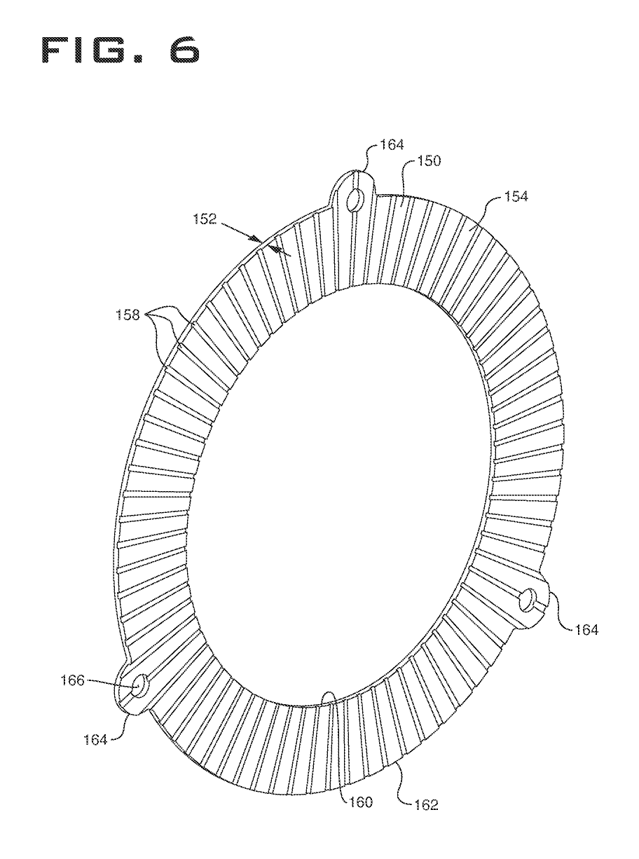

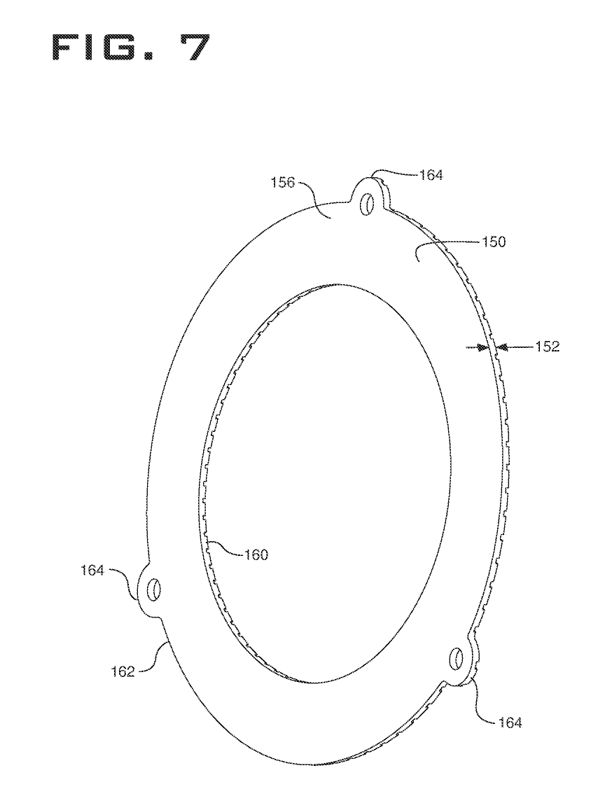

The separator plate 110 may be formed by joining two sub-plates 150. An exemplary sub-plate 150 is depicted in FIGS. 6 and 7. The sub-plate 150 includes a thickness 152 half of the thickness of the separator plate thickness 122. The sub-plate also includes a grooved surface 154 disposed on one axial surface of the sub-plate 150 and a generally smooth surface 156 disposed on the surface opposed to the grooved surface 154. The grooved surface 154 has a plurality of grooves 158 that extend within the thickness 122 of the sub-plate 150 from the inner diameter 160 of the sub-plate 150 to the outer diameter 162. The number of grooves 158 in the sub-plate directly corresponds to the number of apertures 130 that are in the final separator plate 110. The separator plate 110 may be formed when two of the sub-plates 150 are oriented in a facing arrangement with the grooved surfaces 154 positioned against each other with the plurality of grooves 158 aligned. By aligning the grooves 158 of the two sub-plates 150, the apertures 130 of the separator plate 110 are formed and a separator plate 110, such as the separator plate 110, depicted in FIG. 5 is provided.

The formation of the separator plate 110 is simplified by forming it from the two sub-plates 150 as the two sub-plates may be identical. The sub-plates 150 may be cast or machined from a starting material. For example, the starting material may be iron, steel, or any other material used to form separator plates in braking applications.

The separator plate 110 and sub-plates 150 may have one or more tabs 164 provided around the outer diameter 116, 162. Each tab 164 may be provided with a dowel hole 166. The dowel holes 166 may be used to align the sub-plates 150 such that by aligning the dowel holes 166 on two sub-plates having their grooved surfaces 154 facing one another, the plurality of grooves 158 on each of the identical sub-plates 150 are aligned and the apertures 130 of the thereby formed separator plate 110 are properly aligned and formed. Dowels (not shown) passing through the dowel holes 166 may be connected to the center housing 26 for mounting the separator plates 110.

### INDUSTRIAL APPLICABILITY

The disclosed separator plate may be applicable to any brake system where cooling and longevity of brake disks are an issue Improved cooling and lubrication of wet brake assemblies may by achieved by using centrifugal force to direct oil through radially located apertures. The rotating components of the disclosed braking system may have an extended useful life because of reduced friction between rotating components. Cooling of braking system 60 will now be described.

Referring to FIG. 3, when a braking event of drive assembly 10 is desired by an operator, the plurality of brake disks 64 may be pushed together, or in other words compressed, by actuator 62, resisting the rotation of output shafts 20 and 22. This braking event may generate friction and heat. To reduce friction and to cool brake disks 64, center housing 26 may be filled with oil up to a fill line A′-A′. Fill line A′-A′ may be located approximately at an assembled gravitational halfway point within center housing 26 (i.e., below conduits 50). While brake hub 70 is rotated in either a forward or reverse direction, centrifugal forces generated by this rotation may direct oil radially outward through brake hub apertures 96 and into braking system 60. This may cause oil to then pass through the apertures 130 of the separator plates 110. The rotation of the splines 88 of the brake hub 70 in the oil may additionally act as a pseudo-pump that can drive the motion of oil through the apertures 130 of the separator plates. By providing the apertures 130 as cooling passages through the separator plates 110 rather than providing grooves on a surface of an alternative separator plate, the smooth surface 112 of the described separator plate 110 may provide a better frictional interaction with the friction disks 64 of the braking system. Additionally, the apertures 130 described herein allow for the flow of cooling oil through the separator plates 110 of the brake system 60 despite the separator plates 110 not being rotating components. Instead, as described above, the cooling oil is driven through the apertures 130 of the separator plates 110 by the rotation of adjacent components, such as the brake hub 70.

The oil may then exit braking system 60 and center housing 26 via conduits 50 and 51, carrying heat away from braking system 60. The location of conduits 50 at the assembled two o'clock and ten o'clock positions may facilitate oil flow through braking system 60 during both forward and reverse rotation of brake hub 70. That is, during forward rotation, more oil may flow through the two o'clock conduit, and during reverse rotation, more oil may flow through the ten o'clock conduit.

In one exemplary embodiment, drive assembly 10 may have an oil flow ratio of approximately 0.8-1.2. The oil flow ratio may be defined as the total flow area of apertures 96 compared with the total flow area of conduits 50 and 51. When drive assembly 10 is designed to have an oil flow ratio of approximately 0.8-1.2, a low or zero pressure change may be achieved across drive assembly 10. This ratio may increase an amount of time that oil spends within brake system 60, while simultaneously generating little pressure head in conduits 50 and/or 51. Increased pressure at conduits 50 and/or 51 could trap oil within brake system 60 and increase shearing drag losses.

Separator plate 110 may provide improved oil flow and lubrication in braking system 60 by utilizing the centrifugal forces generated during rotation of brake hub 70. Operating costs may be reduced because less oil may be required to lubricate and cool braking system 60. The disclosed brake hub may provide a simple and elegant mechanism for cooling a wet brake assembly, and help extend brake disk, spacer, and/or brake hub life by reducing friction and wear of rotating components.

It will be apparent to those skilled in the art that various modifications and variations can be made to the disclosed brake hub without departing from the scope of the disclosure. Other embodiments of the brake hub will be apparent to those skilled in the art from consideration of the specification and practice of the brake hub disclosed herein. It is intended that the specification and examples be considered as exemplary only, with a true scope of the disclosure being indicated by the following claims and their equivalents.

What is claimed is:

1. A separator plate for a brake assembly, comprising:
a plate-like ring including an inner diameter, an outer diameter, a thickness, a generally smooth surface disposed on opposing sides of the plate-like ring spaced apart by the thickness, and a plurality of apertures extending from the inner diameter to the outer diameter within the thickness of the ring,
wherein a cross-section of each of the plurality of apertures remains generally consistent in cross-sectional area along the extent from the inner diameter to the outer diameter.

2. The separator plate of claim 1, wherein plurality of apertures is a number of apertures determined by the formula:
$$π ( {OD}^{2} - {ID}^{2} ) = 4 A ( \frac{OD - ID}{2} ) η$$
wherein,
OD=outer diameter
ID=inner diameter
A=aperture cross-sectional area
ç=number of apertures

3. The separator plate of claim 1, wherein the number of apertures is about 40 to about 80.

4. The separator plate of claim 3, wherein the number of apertures is about 50 to 70.

5. The separator plate of claim 4, wherein the number of apertures is 60.

6. The separator plate of claim 1, wherein each aperture has a cross sectional area of about 15 mm² to about 30 mm².

7. The separator plate of claim 1, wherein each aperture has a circular cross-section.

8. The separator plate of claim 1, wherein the separator plate is formed from two sub-plates, each sub-plate comprising a thickness half of the separator plate thickness, a generally smooth surface disposed on one axial surface of the sub-plate, and a grooved surface including a plurality of grooves disposed on the surface opposed to the smooth surface, and wherein the grooved surfaces of the two sub-plates are oriented in a facing arrangement with the plurality of grooves on each sub-plate aligned to form the separator plate.

9. The separator plate of claim 8, wherein the sub-plates are identical.

10. The separator plate of claim 8, wherein each of the sub-plates further comprises one or more tabs located at an outer edge and a dowel hole located in each of tab.

11. The separator plate of claim 10, wherein the alignment of the dowel holes of the sub-plates ensures the plurality of grooves of each sub-plate forming the separator plate are aligned.

12. The separator plate of claim 1, wherein the plurality of apertures extend radially between the inner diameter and the outer diameter.

13. A brake assembly, comprising:
a plurality of brake disks;
at least one separator plate disposed between the plurality of friction plates, the at least one separator plate comprising a plate-like ring including an inner diameter, an outer diameter, a thickness, a generally smooth surface disposed on opposing sides of the plate-like ring spaced apart by the thickness, and a plurality of apertures extending from the inner diameter to the outer diameter within the thickness of the ring, wherein a cross-section of each of the plurality of apertures remains generally consistent in cross-sectional area along the extent from the inner diameter to the outer diameter; and
an actuator selectively movable towards the plurality of friction plates and the at least one separator plate by pressurized fluid to compress the plurality of friction plates and the at least one separator plate.

14. The brake assembly of claim 13, wherein plurality of apertures is a number of apertures determined by the formula:
$$π ( {OD}^{2} - {ID}^{2} ) = 4 A ( \frac{OD - ID}{2} ) η$$
wherein,
OD=outer diameter
ID=inner diameter
A=aperture cross-sectional area
ç=number of apertures

15. The brake assembly of claim 13, wherein each aperture has a cross sectional area of about 15 mm² to about 30 mm².

16. The brake assembly of claim 13, wherein each aperture has a circular cross-section.

17. The brake assembly of claim 13, wherein the separator plate is formed from two sub-plates, each sub-plate comprising a thickness half of the separator plate thickness, a generally smooth surface disposed on one axial surface of the sub-plate, and a grooved surface including a plurality of grooves disposed on the surface opposed to the smooth surface, and wherein the grooved surfaces of the two sub-plates are oriented in a facing arrangement with the plurality of grooves on each sub-plate aligned to form the separator plate.

18. The separator plate of claim 17, wherein each of the sub-plates further comprises one or more tabs located at an outer edge and a dowel hole located in each of tab.

19. The separator plate of claim 18, wherein the alignment of the dowel holes of the sub-plates ensures the plurality of grooves of each sub-plate forming the separator plate are aligned.

20. A drive assembly, comprising:
a center housing;
an output shaft passing through the housing to engage a traction device;
a brake hub disposed around the output shaft,;
a plurality of brake disks rotationally connected to the brake hub;
a plurality of separator plates connected to the housing at an outer periphery, axially disposed between the plurality of friction plates, one or more of the plurality of separator plates comprising a plate-like ring including an inner diameter, an outer diameter, a thickness, a generally smooth surface disposed on opposing sides of the plate-like ring spaced apart by the thickness, and a plurality of apertures extending from the inner diameter to the outer diameter within the thickness of the ring, wherein a cross-section of each of the plurality of apertures remains generally consistent in cross-sectional area along the extent from the inner diameter to the outer diameter; and
an actuator selectively movable towards the plurality of brake disks and separator plates by pressurized fluid to compress the plurality of brake disks and the plurality of separator plates.
